(19) United States
(12) Patent Application Publication
(10) Pub. No.: US 2006/0192393 A1
(43) Pub. Date: Aug. 31, 2006

(54) Johansson actuator

(76) Inventors: Kenneth Lester Johansson, North Grafton, MA (US); John Louis Brady, Worcester, MA (US)

Correspondence Address: Kenneth Lester Johansson, 114 Old Westboro Road, North Grafton, MA, 01536, US

(21) Appl. No.: 11/361,466

(22) Filed: Feb. 25, 2006

Related U.S. Application Data
(60) Provisional application No. 60/656,734, filed on Feb. 26, 2005.

(51) Int. Cl. E05B 65/10

(52) U.S. Cl. 292/93

(57) ABSTRACT

Access control is a technology that allows remote locking and unlocking of doors. The information to cause these systems to function is usually derived from keypads, magnetic cards, proximity cards, motion detectors, manually activated switches and time schedules read by a computer. Many of the locking devices on the doors selected for access control are manually activated only. In order to implement an access control system, these devices must be made to activate electrically by some means. The common method to do this is to replace this very good and durable hardware with new hardware that has electric activation incorporated into it. This is a very expensive method to gain the functionality needed. Other methods are also used but the result often compromises security and the locking system integrity. This invention is a new approach to gaining the desired functionality, without compromising the safety, security and locking integrity of the door and lock system. This invention meets the need but at a much more reasonable cost. It is equipment that is added to the existing door hardware.

### FIELD OF INVENTION

The invention relates to access control equipment.

### BACKGROUND

This invention pertains to the field of access control. Access control allows entry into locked areas, based on successfully presenting the required activation information to a control system. This invention allows access control to be added to doors with exit devices (crash bars) without replacing the existing hardware. This is a much more cost effective approach than replacing the exit devices with similar versions that have the electrified activation hardware internal to the device. Implementing access control to doors with existing exit devices, by the addition of an add-on actuation device to each door, is the main thrust of this invention.

Panic hardware, panic exit devices, exit devices, exit hardware, and crash bars are names that are used interchangeably for the same door locking devices.

### BRIEF SUMMARY OF THE INVENTION

This invention is an add on actuator which is mounted on a door with exit hardware. The invention is mounted to the door such that it straddles the exit hardware. The Johansson Actuator is connected to the access control system. When the access control system sends a signal to retract the exit device, the Johansson Actuator moves the exit device bar, just as a person would do, when opening the door. If the access control system activation is for a short time period, such as the time needed to enter a doorway, the Johansson Actuator will then operate in the opposite direction, thus relocking the door. The main advantages of the Johansson Actuator are twofold. The first is that the Johansson Actuator does not compromise the integrity of the door locking systems that it is used with. The second is that the Johansson Actuator is a much more cost effective approach to implementing access control, on doors with preexisting exit devices, than replacing those exit devices with electrified versions.

### DESCRIPTION OF THE SEVERAL VIEWS OF THE DRAWINGS

FIG. 1, item 1, is a representation of a typical panic exit device where the center bar, item 2, is pushed toward the door to activate the device and retract the latch, item 3, which in turn releases the door on which it is mounted.

FIG. 2 is an exploded view of the Johansson Actuator for Embodiment 1. The frame of the Johansson Actuator, item 4, straddles the panic hardware, item 1, and is mounted to the door. The gear motor, item 5, is mounted to the frame, item 4. The eccentric cam, item 6, is mounted on the shaft of the gearmotor, item 5. The eccentric cam, item 6, when it is rotated contacts the push bar, item 2. The limit switches, items 7 and 8, bound the rotation of the eccentric cam, item 6.

FIG. 3 is an assembly drawing of the Johansson Actuator. The basic dimensions of the frame are indicated. The frame, item 4, is adjusted to accommodate the gearmotor, item 5, which is a purchased part.

FIG. 4 shows the open/close input signal that is applied to the Johansson Actuator input, item 26. The input signal has two allowed states. The released state of the Johansson Actuator, corresponding to the secure or locked state of the door, is represented by items 9 and 12. The actuated state of the Johansson Actuator, corresponding to the open state of the door, is represented by item 10. The voltage between 0.9 and 3 volts, item 11, is undefined and is not allowed. The input circuitry of FIG. 7 can be easily tailored to accommodate different open and close voltage levels.

FIG. 5 is a simplified description of the output stages of the H bridge power integrated circuit, U3, item 21. Switches S1 and S4 operate as a pair. Switches S3 and S2 also operate as a pair. The direction of rotation of the motor M of item 5, is determined by which pair of switches is turned on.

FIG. 6 is a drawing of the eccentric cam, item 6.

FIG. 7 is the schematic of the Johansson Actuator. Items 14 and 15 comprise the main power supply rails which are derived from the access control system power. This voltage can range from 12 to 40 volts d.c. Item 15 is a 5 volt 3 terminal regulator which provides the 5 volt logic supply rail, item 16. Items 17, 18, 19 and 20 are CMOS open drain Schmidt trigger NAND GATES. Item 21 is an H bridge power integrated circuit with internal logic. Item 5 is a dc bidirectional gearmotor. Limit switches, items 22 and 23, bound the rotation of the eccentric cam, item 6. Signals, items 24 and 25, are derived from limit switches, items 22 and 23. The open/close signal, item 26, is provided by the access control system.

FIG. 8 is the parts list for Embodiment 1. The special parts are listed with part numbers or locations where they can be purchased. The general purpose parts are listed by value and type.

FIG. 9 is a conceptual drawing of the Johansson Actuator applied to Embodiment 2. The exit device, item 27, does not have a push bar that moves perpendicular to the surface of the door as in embodiment 1. Instead Embodiment 2 has a hinged horizontal tilt bar, item 28, which is moved down and inward toward the surface of the door, to release the door. The Johansson Actuator is mounted below the panic hardware. A flexible cable, item 29, is attached to the horizontal bar, then passed over a pulley, item 30, and then connected to a groove in the surface of the eccentric cam, item 6.

### DETAILED DESCRIPTION

This invention relates to the field of Access Control. Access control is a technology that uses various information sources translated into electrical energy, which is then used to allow doors to be momentarily unlocked, opened for egress or ingress, and then relocked. The information sources can be keypads, magnetic card readers, proximity card readers, computers, motion detectors or manually activated switches.

This invention is used in conjunction with the door locking devices that are used to keep doors in a secured state. These devices, on system command will allow the doors to be opened for various time intervals and then relocked. More specifically this invention applies to door locking devices known as panic hardware. Exit devices, or crash bars are other names used interchangeably for panic hardware. These devices by virtue of their design and application are considered to be safe and will always allow egress from the building. These devices may or may not be activated from the exterior side of the door, depending on the type of trim used on the exterior of the door. In order to remotely activate these exit devices, some means of electrical activation is built into these devices. However, huge quantities of these exit devices are in place, and have been used for many years and do not have electrical activation built into them. Implementing access control systems involves dealing with these existing exit devices.

There are three common methods to date, used to incorporate access control with these pre-existing non-electrified exit devices. One method is to replace the exit devices with ones that include internal electrical activation. This is a very expensive solution. The second way is to use electric strikes. This method requires making a cavity in the doorjamb to mount the electric strike into, which can be very labor intensive and may weaken the doorjamb. Furthermore this method only works with Rim exit hardware. Rim exit hardware latches the doorjamb on the side opposite the hinges. Electric strikes cannot be used with Vertical Rod exit hardware. Vertical Rod exit devices latch the door at both the door top and the door bottom. The third method is to permanently open (dog open) the exit device and add a magnetic lock to each door. Typically magnetic locks are located at the top of each door/door jamb. The result of having a door secured only at the top is that the door is vulnerable to damage when someone tries to force it open. The use of a magnetic lock in this configuration compromises the mechanical integrity of an otherwise good locking system.

This invention, named the Johansson Actuator, allows the use of the existing panic hardware. The Johansson Actuator is mounted to the inside surface of the door as an “Add-On Device”. The Johansson actuator is connected to the panic hardware such that the panic hardware functions exactly as it did previously. The use of the Johansson Actuator does not compromise in any way, the safety aspects of the panic hardware. The Johansson Actuator activates the panic hardware just as if a person were pushing the bar of the device. The rigidity of the door locking systems is not compromised in any way by the use of the Johansson Actuator. The Johansson Actuator applies to both Vertical Rod and Rim exit hardware.

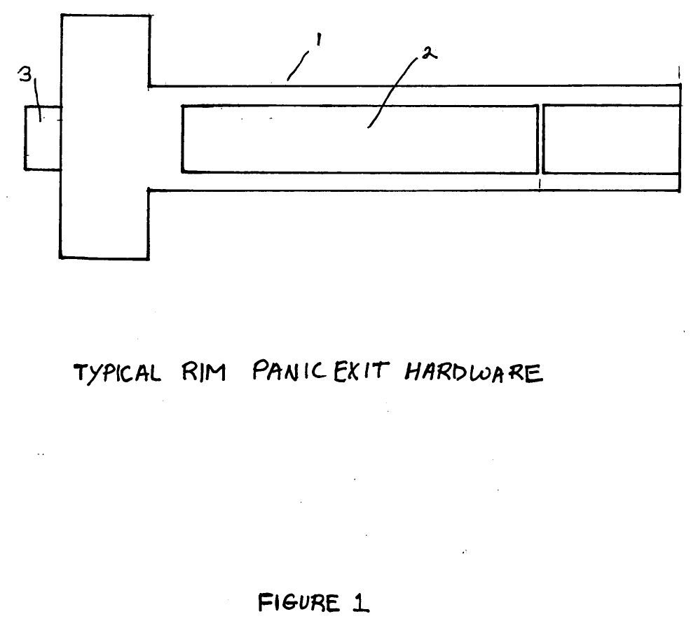

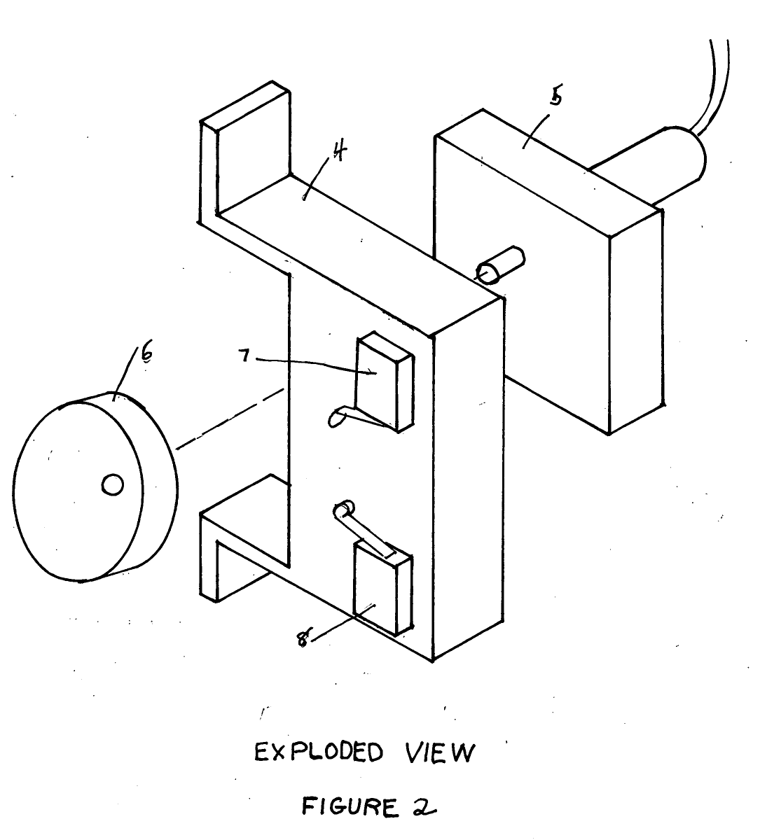

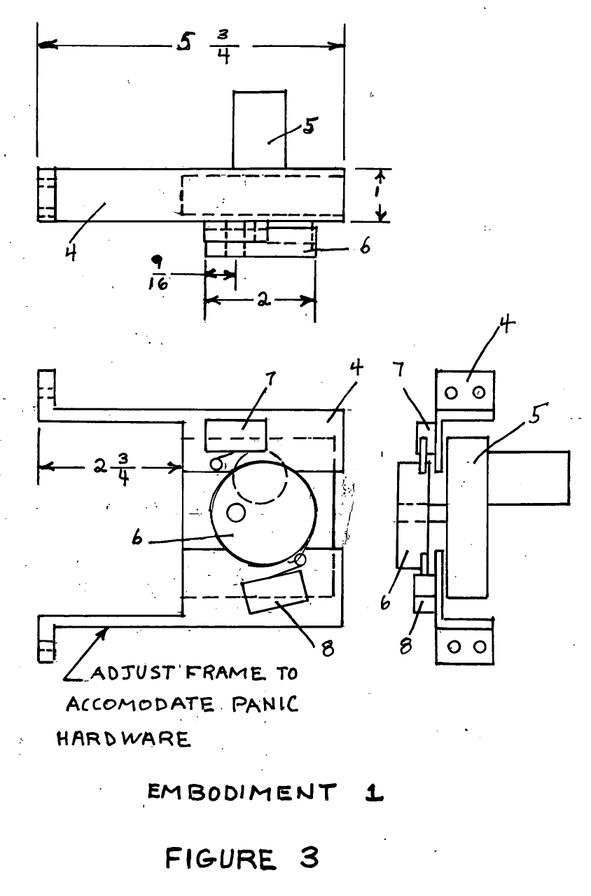

The panic hardware of Embodiment 1, FIG. 1, item 1, uses a bar that is depressed to activate the device. The bar is moved toward the surface of the door, typically 3/4 inch, to release the door. The Johansson Actuator consists of a dc electric gearmotor, item 5, mounted on a frame, item 4, which straddles the bar of the panic hardware. The frame is attached to the door. An eccentric cam, item 6, is mounted on the shaft of the gearmotor, such that when the motor is energized, the shaft rotates and the cam contacts the Panic Hardware bar, item 2, and depresses it. A limit switch, item 22, determines the amount that the bar is depressed.

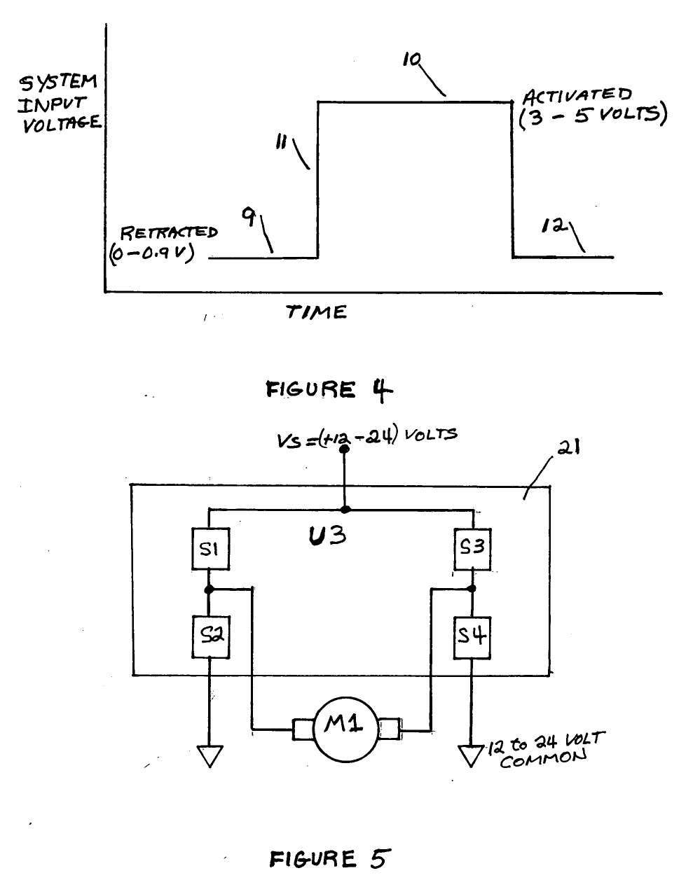

The system control signal has two states. See FIG. 4, items 9 and 12 and item 10. When the door is in the secured state, item 9, and the system controller applies a signal, item 10, to activate the Johansson Actuator, the motor is energized. The gear motor shaft then rotates in a direction to cause the eccentric cam to depress the panic hardware bar. As the bar approaches being fully depressed, the limit switch, item 22, is activated which de-energizes the motor. The panic hardware remains activated (the door is in the unsecured state) as long as the system activating signal is applied to the Johansson Actuator. When the activating signal changes to that of the secured state, item 12, the motor is energized, but in the opposite direction. The eccentric cam rotates in the opposite direction until another limit switch, item 23, is activated, thus de-energizing the motor. The panic hardware remains in this state until it is actuated again.

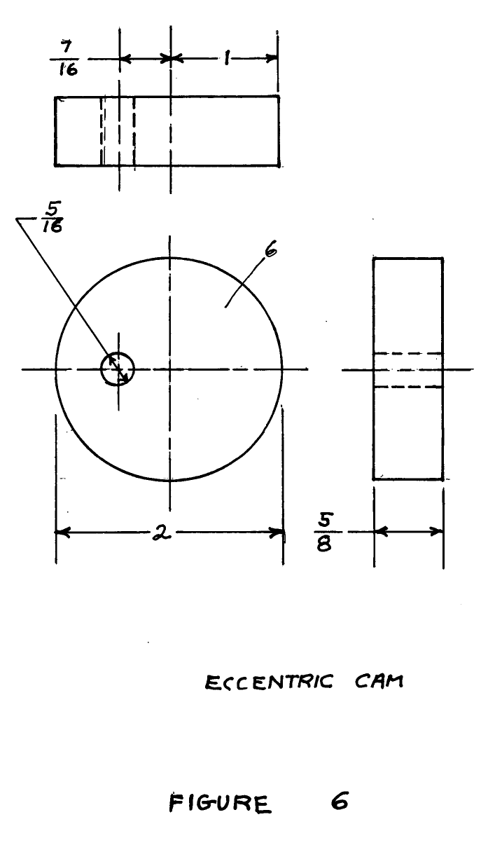

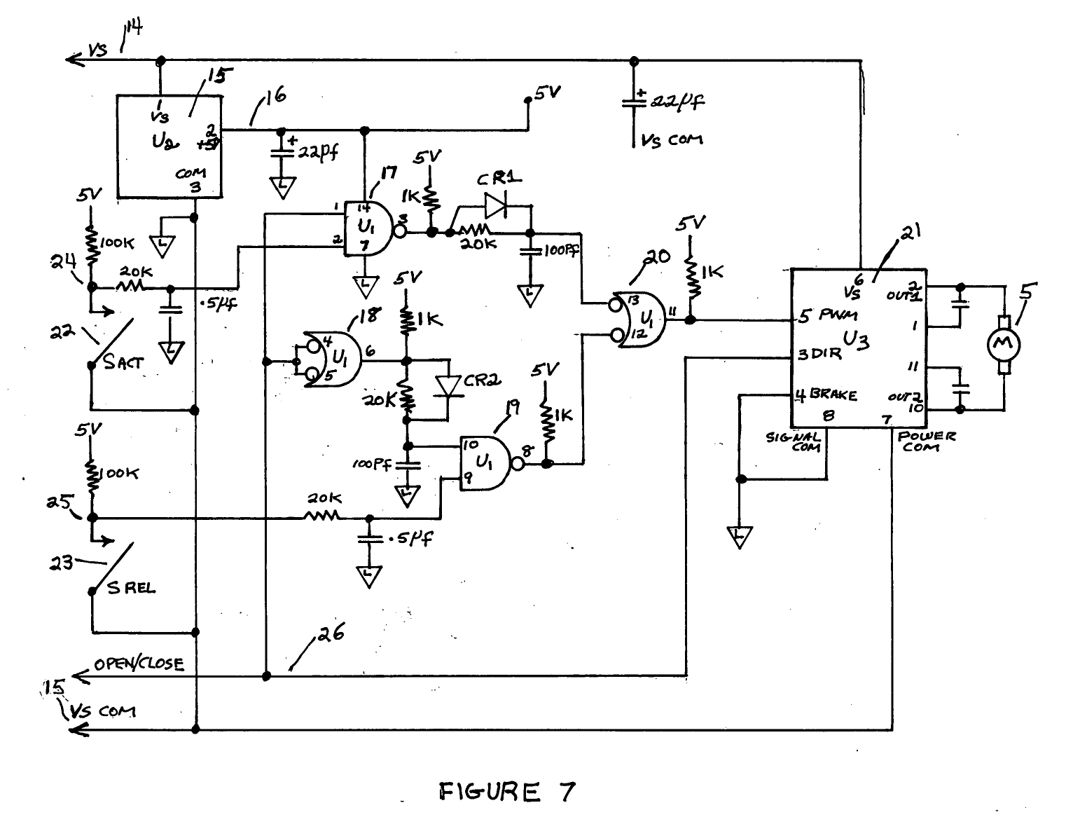

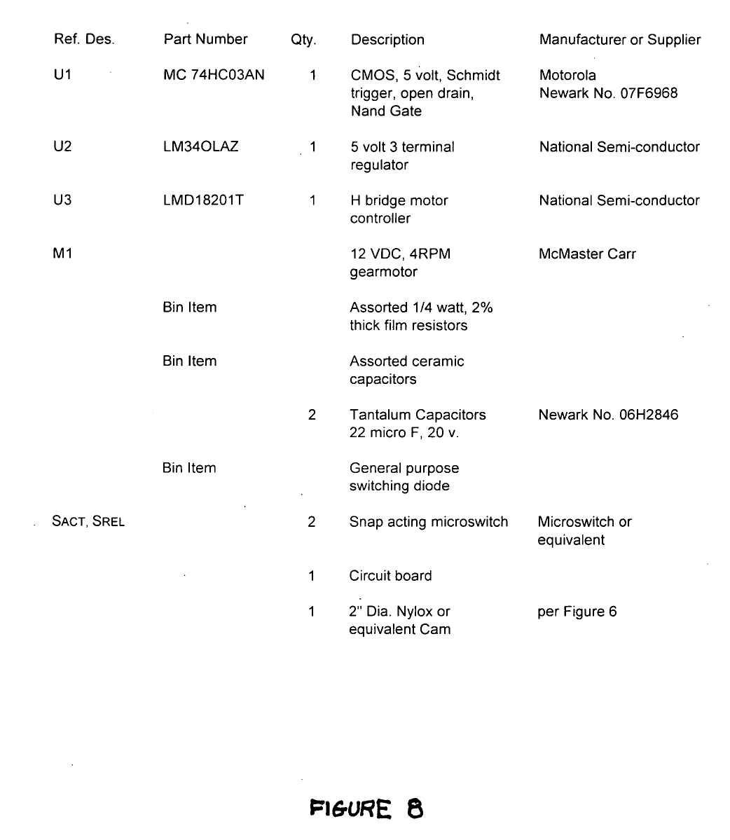

A circuit made up of logic integrated circuits, items 17, 18, 19 and 20, as well as a power integrated circuit, item 21, and a 5 volt regulator, item 15, along with the limit switches, items 22 and 23, control the operation of the motor. FIG. 7 is the schematic of the Johansson Actuator. FIG. 5 is used in the explanation of how the Power Integrated Circuit, item 21 functions.

This concept is based on the fact that the direction of current into the motor of item 5, determines the direction of rotation of the motor. The motor is electrically driven by an H bridge, item 21, which has the capability of reversing the current direction to the motor upon command. The limit switches, items 22 and 23, bound the range of travel. One switch detects when the panic bar is fully depressed and the other switch detects when the panic bar is fully released.

The circuit can easily be tailored to interface to the various requirements of different access control systems. For the configuration shown, which uses a 5 volt logic power supply, a logic zero is represented by a voltage between 0 and +0.9 volts, items 9 and 12. A logic zero represents the released state of the panic bar, which is the secure state of the door. A logic one is represented by an input signal between 3 and 5 volts, item 10. A logic one is used to depress the bar of the panic hardware, thus releasing the door, which then can be opened at will.

When the panic bar is at one of its two stable positions, either released or activated, the logic design prevents the motor from exceeding the limits of travel set by the limit switches. When a limit switch is activated, the motor can only be driven in the direction to move the eccentric cam, item 6 in the return direction.

U3, item 21, the H bridge power integrated circuit, requires two signals to operate. The direction of rotation selection signal is on pin 3 of U3, which originates on a node which is item 26. The run/not run signal is on pin 5 of U3, which originates from the output of U1, item 20. A logic one, (+5 volts), on this pin causes one of the two pairs of power devices within this integrated circuit to turn on. The direction signal determines which pair turns on. A simplified drawing of the H bridge circuit is shown in FIG. 5.

The internal logic of U3, item 21, is configured such that internal switches S1 and S2 cannot be on at the same time. Similarly, internal switches S3 and S4 cannot be on at the same time. When S1 and S4 are on, the motor will run in one direction. When S3 and S2 are on, the motor will run in the opposite direction.

The origination of the direction and run/not run signals, is as follows. A logic zero is represented by 0 to +0.9 volts. A logic one is represented by +3 to +5 volts. The run signal is a logic one out of pin 11, item 20. The run signal is generated when either of the input signals to U1, item 20, is a logic zero. In the circuit of the Johansson Actuator, a logic zero cannot be on both inputs of U1, item 20, at the same time. This is because both limit switches cannot be activated at the same time. However, logic ones can be on both inputs to U1, item 20, which will result in a logic zero on the output of U1, item 20, and consequently on the run/not run control, pin 5, of item 21.

The limit switches present a logic zero to the input of their respective gates when they are in the limit condition. If the switches are not in the limit condition, they present a logic one, to the inputs of their respective gates.

When the door is secured, the exit device is in the fully released position and the limit switch, item 23, presents a logic zero to node item 25, which is one of the inputs to U1 item 19. The other limit switch, item 22, presents a logic one to node 24, which is one of the inputs to U1 item 17. When the open/close signal, item 26, is a logic zero, the output of U1, item 17, is a logic one. Also, under these same conditions, the output of U1 item 19, is also a logic one. Under these conditions, the motor of item 5, will not run.

If the system open/close signal, on item 26, becomes a logic one, the output of U1 item 17, becomes a logic zero, and the motor is turned on, in a direction, to depress the exit bar. This will continue until the limit switch, item 22, closes and then node, item 24, becomes a logic zero. When this happens, the output of U1, item 17, becomes a logic one and the motor stops, and remains stopped, for as long as these conditions exit.

When the system open/close signal on item 26 is made a logic zero, which is the system command to release the exit device and thus secure the door, the output out of U1 item 19, becomes a logic zero. The motor now runs in the opposite direction which releases the exit bar. When the exit bar is fully released, the limit switch, item 23, presents a logic zero to node 25, causing the output of U1, item 19, to become a logic one. The motor stops and remains in this position until conditions change.

The resistor, capacitor, diode, circuits at the inputs and outputs of U2 items 17, 18 and 19 are one way time delays so that the signals to U3 item 21 are presented in the correct order to avoid timing problems.

The resistors on the outputs of U1 items 17, 18, 19 and 20 are also connected to +5 volts. These are pull-up resistors because items 17, 18, 19 and 20 are open drain devices.

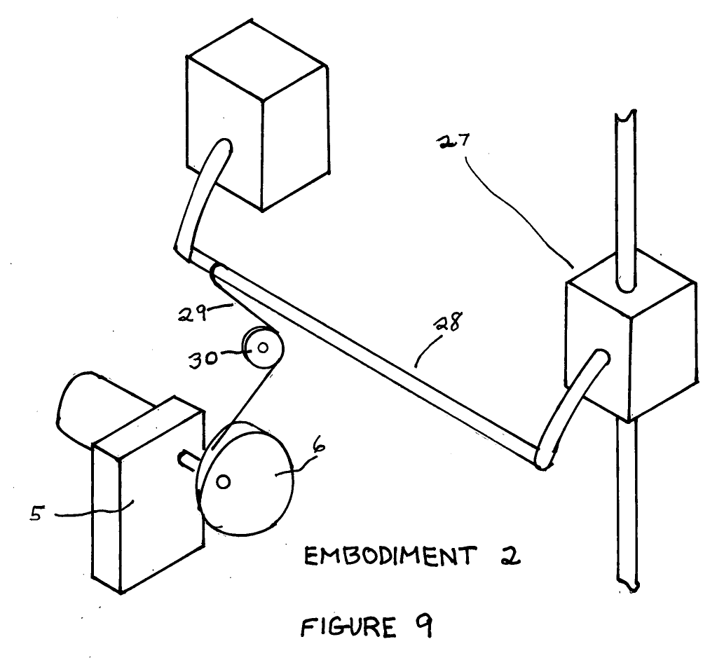

The panic hardware of Embodiment 2 (FIG. 8) has a horizontal member (a rod or a tube) that is connected to two pivoting arms, one on each stile of the door. The pivoting arms are attached to the door by mounting brackets. The panic hardware is activated by pushing on the tube which causes the bar and its pivoting arms to swing down in an arc, toward the door. One of the pivoting arms is connected to the door latching hardware. The other pivoting arm is typically spring loaded which causes the tube to return to the secured position when the tube is released.

The Johansson Actuator of Embodiment 1, with the addition of several parts, makes Embodiment 2.

The Johansson Actuator of Embodiment 2 does not straddle the panic tube as it does in Embodiment 1. Instead it is located and mounted under the tube of the panic hardware and preferably close to the hinge side of the door. A flexible cable, item 29, which is attached to the tube of the panic hardware is passed around a pulley, item 30, and then connected to the offset cam of the Johansson Actuator. One of the switches, which is used to limit the travel of the offset cam, is positioned so that when the Johansson Actuator is in the secure state, the tube of the panic hardware is released and just a slight amount of tension is on the cable. The other limit switch is located so that the tube is in the fully activated position when the motor shuts off.

When the door is in the secured state, as determined by the access control system, the panic hardware of Embodiment 2 can be manually actuated by a person by pushing the tube forward, just as if the Johansson Actuator was not present. When the tube of the panic hardware is pushed forward, the cable deforms due to compression, thus allowing the forward movement of the tube.

There are other methods of implementing Embodiment 2. These methods use different hardware to connect the offset cam to the cross tube of the exit device. Two examples of different connecting hardware are a compression cylinder and a clevis arm combination. Although the connecting hardware is different for each method, the overall concept is the same.

What is claimed is:

1. The Johansson Actuator is by design and definition a device that is used in conjunction with a non electrified panic exit device. The Johansson Actuator is external to the panic exit device, and is an “Add-On Device”.

2. The Johansson Actuator of claim 1 is part of an access control system and activates the panic exit device upon command.

3. The Johansson Actuator of claim 1 does not compromise in any way the safety features of the panic hardware it is used with.

4. The Johansson Actuator of claim 1 does not compromise in any way the rigidity of the door locking system that it is used with in an application.

5. The Johansson Actuator of claim 1 having been added to a door as part of a panic hardware system, when not activated will allow the panic bar to be activated manually, and will not interfere with manual activation of the panic hardware.

6. The Johansson Actuator of claim 1, having been added to a door as part of a panic hardware system, when actuated will allow the door to be opened and closed at will.

7. The mode of operation of the Johansson Actuator of claim 1 is by design “fail safe” with respect to being able to exit the building. With regard to entering the building it can be made to be either “fail safe” or “fair secure”.

8. The Johansson Actuator of claim 1 is a device that is added to a door containing an exit device. The Johansson Actuator is an electro mechanical device whose input is an electrical signal, typically originating from a computer. The Johansson Actuator of claim 1 then translates this signal into mechanical motion, which is applied to the bar of the exit device and causes it to release the door to allow egress or ingress. The absence of the electrical activation signal is translated by the Johansson Actuator of claim 1 to mechanical motion opposite and equal to the activation motion. Therefore the bar of the panic hardware device is released, thus securing the door.
An alternate method of deactivating the Johansson Actuator of claim 1 is to remove the activation signal and apply a deactivating signal that drives the Johansson Actuator to its deactivated position.

9. The hardware of the Johansson Actuator of claim 1 that translates the electrical signal to mechanical motion can take various forms. Electro-mechanical, electro-pneumatic, or electro-hydraulic translators may be used. The embodiments chosen for initial development use electromechanical translation and are shown in this specification. The development for the remaining types of translation is reserved for a later time by the authors of this specification.

10. The signal path from the computer to the Johansson Actuator of claim 1 is not limited to wires. The path may incorporate wireless devices such as, but not limited to, a radio transmitter and a radio receiver. The wireless information will be encoded in away that will maintain the security and integrity of the information.

11. The panic hardware of claim 1, Embodiment 1 (FIG. 1) uses a bar that is depressed to activate the device. The Johansson Actuator of claim 1, Embodiment 1 consists of a dc electric gearmotor mounted on a frame, which straddles the bar of the panic device. The frame is attached to the door. An eccentric cam is mounted on the shaft of the gearmotor such that when the motor is energized the shaft rotates; the cam contacts the panic hardware bar and depresses the bar. A limit switch determines the amount that the bar is depressed. When an electric signal is applied to activate the Johansson Actuator, of claim 1, Embodiment 1, the motor is energized and the gearmotor shaft rotates in a direction to cause the eccentric cam to depress the panic hardware bar. When the bar is fully depressed, the limit switch is activated which de-energizes the motor. The panic hardware remains activated as long as the electric activating signal is applied to the Johansson Actuator of claim 1, Embodiment 1. When the activating signal is removed, the motor is energized, but in the opposite direction. The eccentric cam rotates in the opposite direction until another limit switch is activated, thus de-energizing the motor. The panic hardware remains in this state until it is actuated again. A circuit made up of logic integrated circuits and power integrated circuits, along with the limit switches, controls the operation of the motor.

12. The panic hardware of claim 1, Embodiment 2 (FIG. 9) has a horizontal member, item 23, (a rod or a tube) that is connected to two pivoting arms, one on each side of the door. The Johansson Actuator of claim 1, Embodiment 2 does not straddle the panic hardware tube as it does in Embodiment 1. Instead it is located and mounted under the panic hardware tube and preferably close to the hinge side of the door. A flexible cable, item 29, which is attached to the tube of the panic hardware is passed around a pulley, item 30, and then connects to the eccentric cam, item 6, of the Johansson Actuator. One of the switches, which is used to limit the travel of the offset cam, is positioned so that when the Johansson Actuator is in the secure state, the tube of the Panic Hardware is released and just a slight amount of tension is on the cable. The other limit switch is located so that the tube is in the fully activated position when the motor shuts off.

13. When the door is in the secured state, as determined by the access control system, the panic hardware of claim 1, Embodiment 2, can be manually actuated by a person by pushing the tube forward, just as if the Johansson Actuator was not present. When the tube of the panic hardware is pushed forward, the cable, item 29, deforms, thus allowing the forward movement of the tube.

14. There are other methods of implementing Embodiment 2 of claim 1. These methods use different hardware to connect the eccentric cam to the cross tube of the exit device. Two examples of different connecting hardware are a compression cylinder and a clevis arm combination. Although the connecting hardware is different for each method, the overall concept is the same. These connecting links will act as a cable does. They will transmit tension forces but will not transmit compressive forces.

15. The invention of the Johansson Actuator of claim 1 is intended to include other possible embodiments of the Johansson Actuator within the above listed claims, and is not limited to the particular embodiments or the descriptions and figures listed or shown.
